(19) United States
(12) Patent Application Publication
(10) Pub. No.: US 2006/0173713 A1
(43) Pub. Date: Aug. 3, 2006

(54) Integrated medical device and healthcare information system

(76) Inventors: Alan Petro, San Jose, CA (US); Richard Pettine JR., West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/291,151

(22) Filed: Dec. 1, 2005

Related U.S. Application Data
(60) Provisional application No. 60/647,319, filed on Jan. 26, 2005.

(51) Int. Cl. G06Q 10/00

(52) U.S. Cl. 705/2

(57) ABSTRACT

A system integrates diagnostic, therapeutic, monitoring and other devices commonly found in a healthcare environment into a Hospital Information System (HIS) to improve the delivery of healthcare. The system uses intelligent, networked diagnostic, therapeutic, monitoring and other devices to provide device performance and availability information. A medical device management system includes a repository of patient medical records and a scheduling system for use in scheduling of a medical procedure for a particular patient. A configuration manager in bidirectional communication with a medical device automatically initiates pre-configuration of the medical device for use in the medical procedure using medical record information of the particular patient derived from the repository, in response to scheduling of the particular patient to receive the medical procedure.

This is a non-provisional application of provisional application Ser. No. 60/647,319 by Alan Petro et al. filed Jan. 26, 2005.

### FIELD OF THE INVENTION

This invention concerns a system for medical device management involving medical device configuration for use in performing a procedure for a patient.

### BACKGROUND OF THE INVENTION

Currently there are few if any standardized protocols that are used in the treatment of patients from admission through evaluation and diagnosis. Consequently, each patient admission is typically managed as a unique situation requiring labor-intensive effort to coordinate a diagnosis and treatment process. This results in inefficient utilization of hardware and labor, as well as operator errors due to incorrect data entry and inaccurate configuration of diagnostic, therapeutic, and monitoring equipment. Another consequence is reduced patient throughput and patient satisfaction, as the diagnostic and treatment process per patient is delayed and extended. Existing systems also use a serial, non-networked process whereby diagnostic, therapeutic, and monitoring equipment is configured using manual clinical labor. This results in additional time being employed, resource constraints and a greater possibility of human induced errors. A system according to invention principles addresses these deficiencies and associated problems.

### SUMMARY OF THE INVENTION

A system utilizes standardized protocols, assessment of clinical resources to best perform the recommended protocols and parallel operations (including pre-configuration of diagnostic, therapeutic, and monitoring equipment) to reduce time involved in treatment processes and errors. A medical device management system includes a repository of patient medical records and a scheduling system for use in scheduling of a medical procedure for a particular patient. A configuration manager in bidirectional communication with a medical device automatically initiates pre-configuration of the medical device for use in the medical procedure using medical record information of the particular patient derived from the repository, in response to scheduling of the particular patient to receive the medical procedure.

### BRIEF DESCRIPTION OF THE DRAWING

FIG. 1 shows a workflow management system, according to invention principles.

FIGS. 2A, 2B and 2C show a first flowchart of a clinical workflow process implemented using a workflow management system, according to invention, principles.

FIGS. 3A, 3B and 3C show a second flowchart of a comparison existing clinical workflow process.

FIG. 4 shows a flowchart of a process employed by workflow management system, according to invention principles.

### DETAILED DESCRIPTION OF THE INVENTION

A workflow management system utilizes standardized treatment protocols and assessment of clinical resources to best perform recommended treatment protocols and parallel operations (such as pre-configuration of diagnostic, therapeutic, and monitoring equipment) to reduce overhead time involved in treatment as well as errors. Workflow as used herein comprises a sequence of tasks, at least partially in a particular order, employed by either, or both, personnel and devices in providing healthcare to a patient. The workflow management system integrates diagnostic, therapeutic, monitoring and other devices commonly found in a healthcare environment into a Hospital Information System (HIS) to improve the delivery of healthcare. The system uses intelligent, networked diagnostic, therapeutic, monitoring and other devices to provide device performance and availability information. Clinical resource availability information is used to plan patient workflow in a clinical setting and to preconfigure diagnostic, therapeutic, monitoring and other devices to accelerate and improve patient care. Further, metrics are collected and analyzed to improve Hospital Information System operational performance. The metrics are stored in a knowledge database available for data mining to support clinical trial data management, for example. The workflow management system facilitates connection and integration of devices of different manufacturers within a workflow using standardized and non-standardized communication interfaces such as DICOM.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

In existing non-automated workflow systems a workflow process is often dependent on the skill and knowledge of a healthcare worker performing a planning function resulting in variable performance and device or personnel unavailability. Existing system using non-automated or automated techniques do not consider availability of diagnostic, therapeutic, monitoring and other resources in real time resulting in delay due to lack of needed resources or delay due to lack of information concerning the resources that are available. This manifests itself in degraded operational performance of a healthcare provider and potential degraded healthcare delivery to the patient. Further, existing systems lack capability for pre-configuration of diagnostic, therapeutic, monitoring and other devices in anticipation of receiving a patient, resulting in delay due to the need to configure these devices upon patient arrival. Existing workflow systems do not effectively consider use of alternative resources when diagnostic, therapeutic, monitoring and other devices are not available.

Further, existing automated patient workflow management systems utilize a serial planning process involving sequential tasks and assume clinical resources are available without benefit of real time understanding of whether or not the assumption is correct. Also, existing systems typically do not use an automated patient workflow planning system and workflow management is performed manually or with little in the way of sophisticated process management. In such systems diagnostic, therapeutic, monitoring and other devices often comprise older products having limited network connectivity, or networked devices configured into small networks that do not provide significant data to HIS systems.

The monitoring of location and performance of mobile diagnostic, therapeutic and other medical devices as well as their availability is not coordinated or centrally automated in existing systems. This results in existing workflow systems lacking information concerning overall performance of the medical devices and their location which impairs device availability causing inefficient use of devices and potentially degraded patient care. Further, the theft of mobile resources may go undetected for an extended period of time because there is no central means of taking real-time inventory. In existing systems individual worker efficiency metrics are not routinely gathered from diagnostic, therapeutic, monitoring and other devices. This lack of effective metrics hampers healthcare worker performance management. Also in existing systems individual diagnostic, therapeutic, monitoring and other devices do not provide comprehensive clinical data to a HIS and therefore an existing HIS does not achieve system wide clinical utility provided by a workflow management system according to invention principles.

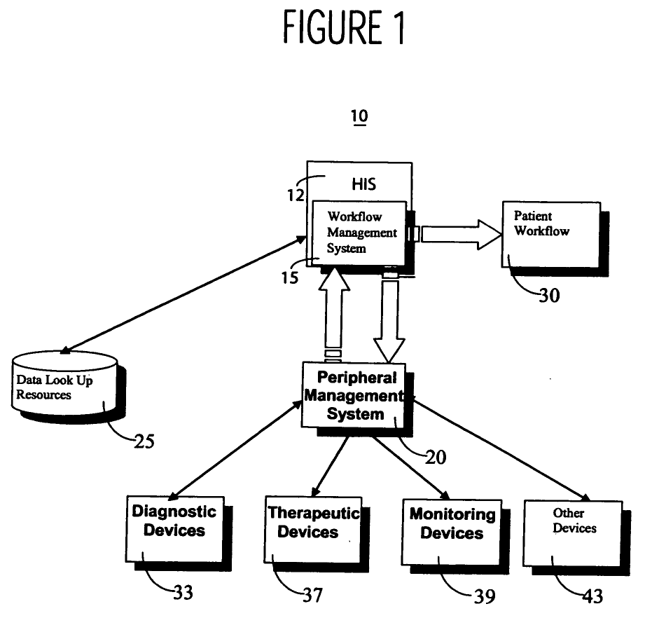

The FIG. 1 workflow management system uses look up tables incorporating relevant data needed to make alternative clinical decisions. Clinicians use this data to make fully informed alternative treatment plans in the event of resource unavailability. The workflow management system automatically archives data comprehensively tracking healthcare activities including results of patient planning decisions. The system automates and accelerates processing of patients in a clinical environment using standardized treatment protocols and configurable diagnostic, therapeutic, and monitoring equipment. The patient workflow management system operating within a hospital information system (HIS), allows diagnostic and treatment protocols to be selected. These in turn are used by the system to advantageously automatically pre-configure diagnostic, therapeutic, and monitoring equipment. This pre-configuration is accomplished using a bi-directional communications interface which reduces delay and healthcare labor and increases patient throughput and satisfaction. The system also reduces error rate associated with manual configuration of diagnostic, therapeutic, and monitoring equipment.

In an embodiment, a hospital information system (HIS) communicates with a piece of equipment (such as a CT scanner) such that the CT scanner can be configured for a specific patient exam (such as an adult head scan). This is done, for example, in a preliminary patient examination stage, or at registration time if applicable, so that a CT scanner is advantageously configured concurrently with the patient examination. This saves time and streamlines a patient treatment workflow by reducing the number of sequential (and manual) steps involved.

The FIG. 1 system 10 comprises a hospital information system (HIS) 12 including a workflow management system 15 integrated with medical devices providing feedback communication to workflow management system 15. Diagnostic devices 33, therapeutic devices 37, monitoring devices 39 and other devices 43 are connected to a workflow management system 15 in a Hospital Information System via peripheral management system 20. Workflow management system 15 also includes a task and resource scheduling system. Unit 20 employs an industry standard DICOM (or HealthLevel 7) compatible interface, for example, in communicating with workflow management system 15 supporting imaging (and other) applications. A DICOM or other interface standard is employed by system 20 in communicating with ancillary diagnostic devices 33, therapeutic devices 37, monitoring devices 39 and other devices 43. The peripheral devices 33, 37, 39 and 43 communicate resource availability, utilization, and location data via system 20 to workflow management system 15.

Further, workflow management system 15 advantageously bi-directionally communicates via system 20 to configure adjustable settings of diagnostic devices 33, therapeutic devices 37, monitoring devices 39 and other devices 43 in advance of a patient arriving for treatment with the devices. For this purpose, system 15 employs data in repository 25 to establish bi-directional communication via system 20 with peripheral devices 33, 37, 39 and 43. System 15 also employs data in repository 25 and patient and healthcare worker task and appointment schedule information 30 to identify and configure adjustable settings of diagnostic devices 33, 37, 39 and 43 with correct treatment settings for a particular patient procedure at a specific time in advance of a patient arriving for treatment. System 15 uses look up tables in repository 25 and patient and healthcare worker task and appointment schedule information 30 to make alternative clinical decisions and configure alternative peripheral devices in the event of a personnel schedule or device usage conflict or unavailability. Workflow management system 15 also acquires and collates system performance data from diagnostic devices 33, therapeutic devices 37, monitoring devices 39 and other devices 43. The system performance data measures hardware and software performance and also includes metrics measuring efficiency of healthcare personnel operating the devices. Workflow management system 15 includes additional functions for performing activities determined in response to a clinical condition of a patient and an assessment of a treating clinician.

In operation, upon patient arrival and admission at a healthcare institution, a diagnosis and treatment plan is developed and system 15 initiates a workflow task sequence implementing the diagnosis and treatment plan. System 15 automatically configures peripheral diagnostic, therapeutic, monitoring and other devices 33, 37, 39 and 43 using a central control system via a standard and common interface through interface system 20. The diagnostic, therapeutic, monitoring and other devices are configured based on a user defined priority system. System 15 also provides automatic routing of data representing patient and device workflow task associated data based on resource availability and automatically reroutes patient task representative workflow data when a primary resource is detected as being unavailable. System 15 provides automatic generation of peripheral device performance and availability metrics using data input from networked peripheral devices 33, 37, 39 and 43 and automated location of these devices using IP port data identifiers and a predetermined map associating the IP port identifiers with physical (geographic) locations. System 15 uses the performance and availability metrics identifying peripheral device utilization and active operational time duration, for example, for healthcare management and equipment utilization optimization. In addition, a centralized preventative and other maintenance scheduling function in system 15 is used to minimize peripheral device downtime and maintain patient workflow flexibility.

System 15 provides a plug-and-play operational environment whereby in response to a peripheral device (e.g., device 33, 37, 39 and 43) being plugged into the system network, its physical location is known using the predetermined map. System 15 uses information indicating physical location of mobile treatment devices (e.g., derived from RFID, GPS or other wireless location detection systems) in a clinical environment in optimizing selection and use of the devices for a particular scheduled patient procedure. The use by interface system 20 of industry standard interfaces (e.g., a DICOM interface) facilitates plug-and-play operation of devices from various manufacturers with HIS systems of different vendors.

System 15 improves patient throughput in a healthcare provider organization due to improved workflow and automatically directs patients to an available and appropriate treatment location based on resource availability. The automatic system operation reduces opportunity for operator errors in configuring diagnostic, therapeutic, and monitoring devices 33, 37, 39 and 43 and stores device configuration information in a record stored in HIS 12 associated with a particular patient treated with the configured device. System 15 concurrently configures peripheral devices 33, 37, 39 and 43 in a preliminary patient examination stage, or at registration time if applicable, so that device is advantageously configured ready for patient treatment or diagnosis. System 15 also centrally allocates time for device 33, 37, 39 and 43 scheduled maintenance activity and more efficiently schedules usage of these devices increasing device utilization and reducing device downtime.

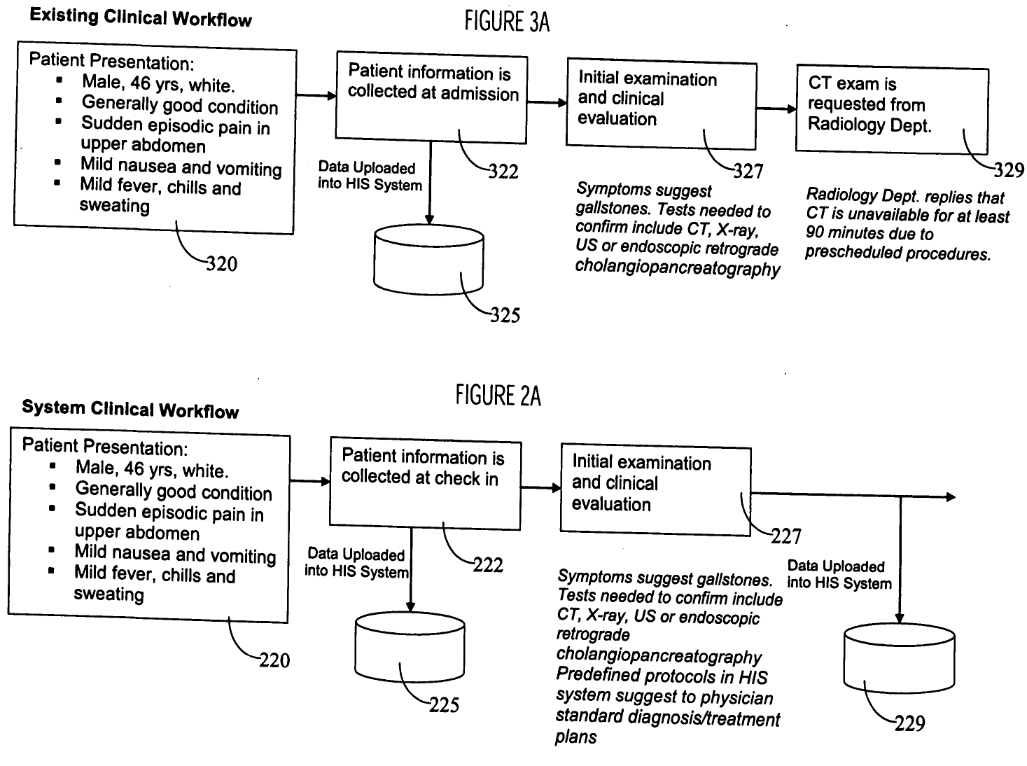

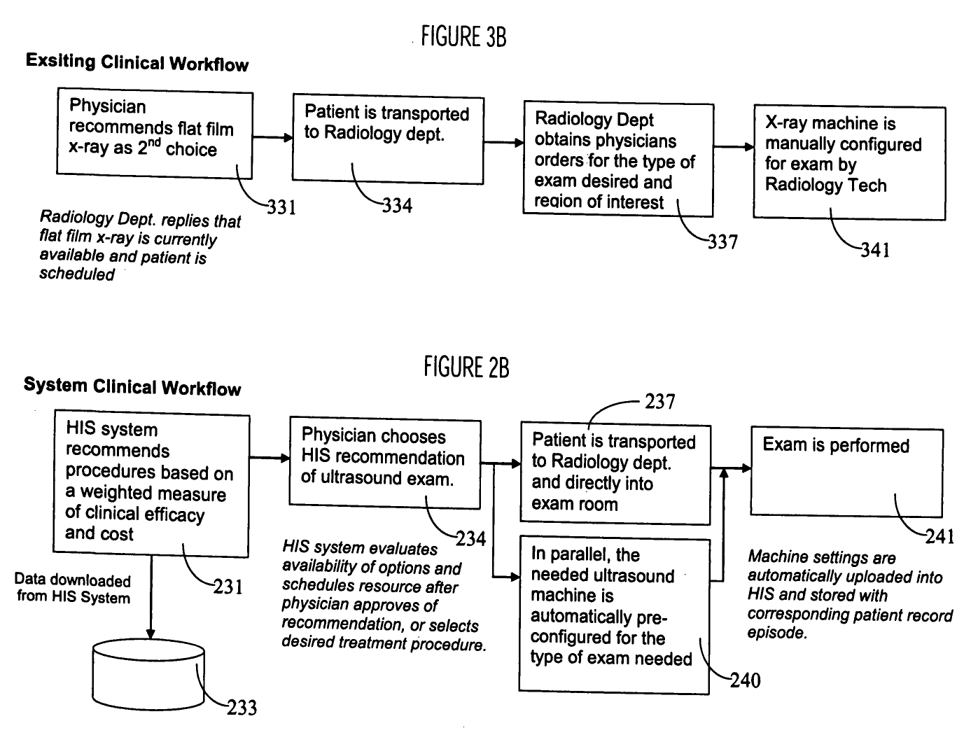

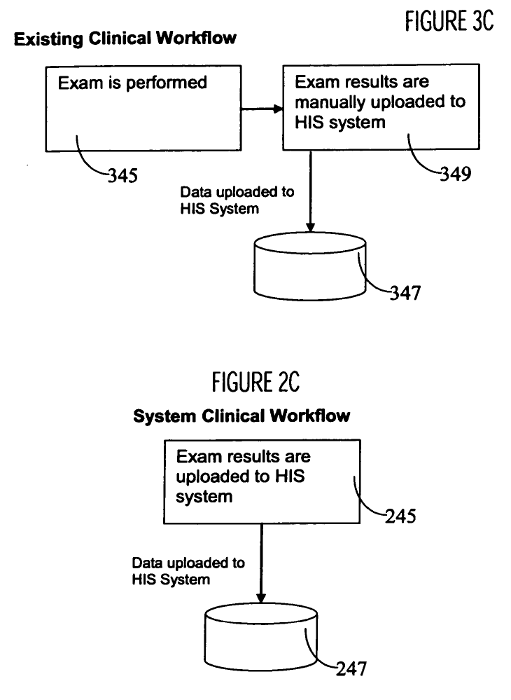

FIGS. 2A, 2B and 2C together show a first flowchart of a clinical workflow process in steps 220-247 implemented using workflow management system 15, according to invention principles. In step 220 of FIG. 2A, a male 46 year old patient is admitted in generally good condition but with symptoms including, sudden episodic pain in the upper abdomen, mild nausea and vomiting as well as mild fever, chills and sweating. Patient medical condition information is collected during admission in step 222 and stored in a repository in HIS 12 in step 225. An initial examination and clinical evaluation is made of the patient in step 227 which determines the symptoms suggest gallstones and that in order to confirm this, a CT scan, X-ray Ultrasound or endoscopic retrograde cholangiopancreatography is necessary. System 15 advantageously provides to a diagnosing physician standard diagnosis and treatment protocols (a schedule of activities and treatments comprising a diagnostic and treatment process) derived from storage in a repository in HIS 12. A diagnosis and assessment report of the patient is stored in a patient record in a repository in HIS 12 in step 229.

In step 231 of FIG. 2B HIS 12 advantageously recommends via a display image multiple candidate treatment procedures based on a weighted measure of clinical efficacy and cost in response to physician entered patient diagnosis and assessment data. Data indicating the multiple candidate treatment procedures is stored in a HIS 12 repository in step 233 A physician selects a particular procedure, specifically an ultrasound examination, from the multiple displayed candidate treatment procedures in step 234. HIS 12 examines availability of personnel and resources for performing the ultrasound examination and schedules the ultrasound examination and indicates unavailability of personnel and equipment resources allocated for the scheduled examination during a period concerned. This is done in response to a physician approving the selected treatment procedure and a scheduled procedure appointment. A physician is also able to select another treatment procedure other than one of the multiple displayed candidate treatment procedures and a scheduled appointment.

The patient is transported to a particular examination room in a Radiology department in step 237 and system 15 in step 240 concurrently automatically pre-configures an ultrasound imaging device with settings for the particular type of examination required. The ultrasound examination is performed in step 241 and data indicating the settings used for the examination is automatically stored in a patient record together with data associated with the examination in a repository in HIS 12. In steps 245 and 247 of FIG. 2C, data representing the ultrasound examination result is stored in the patient record together with the examination ultrasound device settings data in a repository in HIS 12.

FIGS. 3A, 3B and 3C show a second flowchart of an existing clinical workflow process in steps 320-349 for comparison with the process of FIGS. 2A, 2B and 2C employed by the system of FIG. 1. In step 320 of FIG. 3A, a male 46 year old patient is admitted in generally good condition with the symptoms described in connection with step 220 of FIG. 2A. The patient information is collected during admission in step 322 and stored in a HIS repository in step 325. An initial examination and clinical evaluation is made of the patient in step 327 which determines the symptoms suggest gallstones and that in order to confirm this, a CT scan, X-ray Ultrasound or endoscopic retrograde cholangiopancreatography is necessary. A CT scan is requested by a physician in step 329 and the Radiology department replies that a CT is unavailable for at least 90 minutes due to pre-scheduled procedures.

In step 331 of FIG. 3B, the physician selects a flat film X-ray examination as a second choice, the Radiology department replies that a flat film X-ray device is available and the patient is scheduled for the X-ray examination. The patient is transported to a Radiology department in step 334 and the Radiology department obtains a physician order to perform the flat film X-ray type of imaging examination for the patient anatomical region concerned in step 337. An X-ray machine is manually configured by a Radiology technician for the examination in step 341 in response to the physician order. The X-ray examination is performed in step 345. In steps 349 and 347 of FIG. 3C, the result of the X-ray examination is manually stored in the patient record in the HIS.

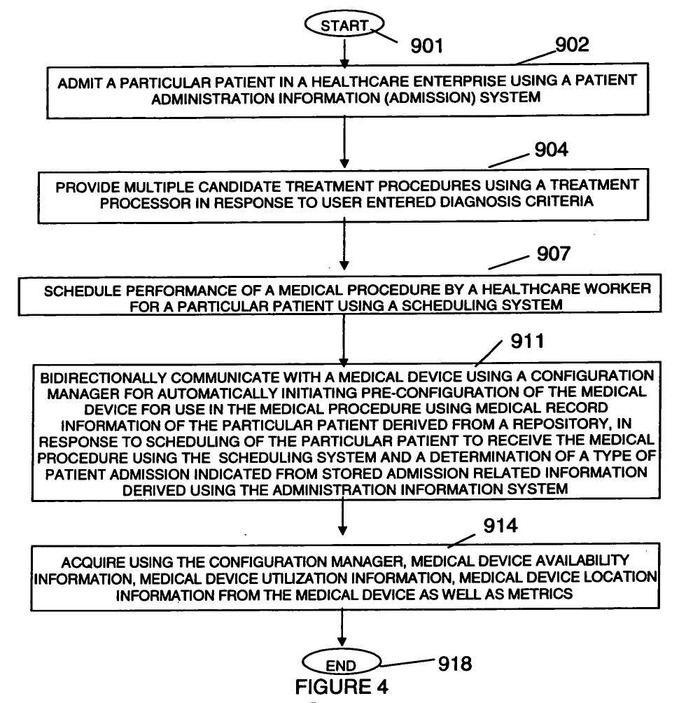

FIG. 4 shows a flowchart of a process employed by system 10 including HIS 12 and workflow management system 15. Following the start in step 901, an administration information and patient admission system in HIS 12 in step 902 is used to admit a particular patient to a healthcare enterprise. A treatment processor in HIS 12 recommends multiple candidate treatment procedures in response to user entered diagnosis criteria in step 904. The multiple candidate treatment procedures are derived based on corresponding weighted measures of clinical efficacy and cost and also on standard treatment protocols. In step 907 a scheduling system in HIS 12 schedules performance of a medical procedure by a healthcare worker for a particular patient. The medical procedure comprises a candidate treatment procedure selected by a user from the multiple candidate treatment procedures.

A configuration manager in system 15 in bidirectional communication with a medical device via interface system 20 automatically initiates pre-configuration of the medical device in step 911 for use in the medical procedure using medical record information of the particular patient derived from a repository in HIS 12. This is done in response to scheduling of the particular patient to receive the medical procedure using the scheduling system and determination of a type of patient admission indicated from stored admission related information derived using the administration information system or in response to the nature of the admission indicated from stored admission related information. The configuration manager uses system 20 employing a standard interface in bidirectionally communicating with the medical device. A standard interface includes, a DICOM compatible interface, a HealthLevel7 (HL7) compatible interface or a MIB (Medical Interface Bus) compatible interface, for example. The medical device is a therapeutic device e.g., a radiation therapy device or sonic device, a diagnostic imaging device, e.g., an MRI, CT scan, X-ray, Ultrasound device or a patient parameter monitoring device, e.g. a vital sign monitoring device.

The configuration manager automatically initiates pre-configuration of the medical device with settings for the medical procedure. The medical procedure may comprise an imaging procedure of a particular anatomical region such as an MRI, CT scan, X-ray, Ultrasound etc. and the configuration manager stores the settings in a medical record associated with the particular patient and with results of the imaging procedure. The configuration manager automatically pre-configures the medical device concurrently with performance of an activity supporting performance of the medical procedure. The activity supporting performance of the medical procedure comprises at least one of, examination of the particular patient, transportation of the particular patient, admission of the particular patient, scheduling of resources supporting performance of the medical procedure or ordering of resources supporting performance of the medical procedure.

The configuration manager automatically initiates pre-configuration of another different second medical device for use in a medical procedure, in response to a determination of unavailability of a first medical device for the scheduling of the particular patient to receive a medical procedure. The configuration manager automatically initiates pre-configuration of the first and different second medical device in a predetermined priority. The configuration manager also automatically initiates communication of device settings, clinical data and task representative data to one or more destinations, in response to a determination of unavailability of the first medical device for the scheduling of the particular patient to receive the medical procedure. The configuration manager in step 914 acquires medical device availability information, medical device utilization information and medical device location information from multiple medical devices via interface system 20. The configuration manager also acquires metrics for use in evaluating medical device performance as well as metrics for use in determining efficiency of use of a medical device by a healthcare worker and metrics for use in evaluating software performance. The process of FIG. 4 terminates at step 918.

The system, process and user interface display images presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and processes of FIGS. 1-4, may be implemented in hardware, software or a combination of both.

What is claimed is:

1. A medical device management system, comprising:
a repository of patient medical records;
a scheduling system for use in scheduling performance of a medical procedure by a healthcare worker for a particular patient; and
a configuration manager in bidirectional communication with a medical device for automatically initiating pre-configuration of said medical device for use in said medical procedure using medical record information of said particular patient derived from said repository, in response to scheduling of said particular patient to receive said medical procedure using said scheduling system.

2. A system according to claim 1, including
an admission system used for admission of said particular patient in a healthcare enterprise; and
said configuration manager automatically initiates pre-configuration of said medical device for use in a medical procedure, in response to determination of the nature of said admission indicated from stored admission related information.

3. A system according to claim 1, wherein
said configuration manager acquires at least one of, (a) medical device availability information, (b) medical device utilization information and (c) medical device location information from said medical device.

4. A system according to claim 1, wherein
said configuration manager acquires information comprising metrics for use in evaluating medical device performance.

5. A system according to claim 1, wherein
said configuration manager acquires information comprising metrics for use in determining efficiency of use of said medical device by a healthcare worker.

6. A system according to claim 1, wherein
said configuration manager acquires information comprising metrics for use in evaluating software performance.

7. A system according to claim 1, wherein
said configuration manager automatically pre-configures said medical device concurrently with performance of an activity supporting performance of said medical procedure.

8. A system according to claim 7, wherein
said activity supporting performance of said medical procedure comprises at least one of, (a) examination of said particular patient, (b) transportation of said particular patient and (c) admission of said particular patient.

9. A system according to claim 7, wherein
said activity supporting performance of said medical procedure comprises at least one of, (a) scheduling of resources supporting performance of said medical procedure and (b) ordering of resources supporting performance of said medical procedure.

10. A system according to claim 1, including
a treatment processor for providing a plurality of candidate treatment procedures in response to user entered diagnosis criteria and
said medical procedure for performance by said healthcare worker for said particular patient comprises a candidate treatment procedure selected by a user from said plurality of candidate treatment procedures.

11. A system according to claim 10, wherein
said plurality of candidate treatment procedures are derived based on corresponding weighted measures of clinical efficacy and cost.

12. A system according to claim 11, wherein
said plurality of candidate treatment procedures are derived based on standard treatment protocols.

13. A system according to claim 1, wherein
said configuration manager automatically initiates pre-configuration of said medical device with settings for said medical procedure and stores said settings in a medical record associated with said particular patient.

14. A system according to claim 13, wherein
said medical procedure is an imaging procedure of a particular anatomical region and
said configuration manager stores said settings in a medical record in association with results of said imaging procedure.

15. A system according to claim 1, wherein
said medical device is at least one of, (a) a therapeutic device, (b) a diagnostic imaging device and (c) a patient parameter monitoring device.

16. A system according to claim 1, wherein
said configuration manager uses a standard interface in bidirectionally communicating with said medical device wherein
said standard interface comprises at least one of, (a) a DICOM compatible interface, (b) a HealthLevel7 (HL7) compatible interface and (c) a MIB (Medical Interface Bus) compatible interface.

17. A system according to claim 1, wherein
said medical device is a first medical device and
said configuration manager automatically initiates pre-configuration of another different second medical device for use in a medical procedure, in response to a determination of unavailability of said first medical device for said scheduling of said particular patient to receive said medical procedure.

19. A system according to claim 18, wherein
said configuration manager automatically initiates pre-configuration of said first and different second medical device in a predetermined priority.

20. A system according to claim 1, wherein
said configuration manager automatically initiates communication of device settings, clinical data and task representative data to one or more destinations, in response to a determination of unavailability of said first medical device for said scheduling of said particular patient to receive said medical procedure.

21. A medical device management system, comprising:
a repository of patient medical records;
a scheduling system for use in scheduling performance of a medical procedure by a healthcare worker for a particular patient; and
a configuration manager in bidirectional communication with a medical device for automatically initiating pre-configuration of said medical device for use in said medical procedure using medical record information of said particular patient derived from said repository, in response to scheduling of said particular patient to receive said medical procedure using said scheduling system, said configuration manager automatically pre-configures said medical device concurrently with performance of an activity supporting performance of said medical procedure.

22. A system according to claim 21, wherein
said activity supporting performance of said medical procedure comprises at least one of, (a) examination of said particular patient, (b) transportation of said particular patient and (c) admission of said particular patient.

23. A medical device management system, comprising:
a repository of patient medical records;
an administration information system for use in admitting a particular patient in a healthcare enterprise; and
a configuration manager in bidirectional communication with a medical device for automatically initiating pre-configuration of said medical device for use in said medical procedure using medical record information of said particular patient derived from said repository, in response to determination of a type of patient admission indicated from stored admission related information derived using said administration information system.
